(19) United States
(12) Patent Application Publication
(10) Pub. No.: US 2014/0105063 A1
(43) Pub. Date: Apr. 17, 2014

(54) DUTY CYCLE CONTROL METHOD AND APPARATUS TO MITIGATE LATENCY FOR DUTY CYCLE-BASED WIRELESS LOW-POWER MAC

(71) Applicant: Electronics and Telecommunications Research Institute, Daejeon (KR)

(72) Inventors: Jong-Soo JEONG, Daejeon (KR); Jee-Hoon LEE, Seoul (KR)

(73) Assignee: Electronics and Telecommunications Research Institute, Daejeon (KR)

(21) Appl. No.: 14/018,336

(22) Filed: Sep. 4, 2013

(30) Foreign Application Priority Data
Oct. 16, 2012 (KR) 10-2012-0115004

(51) Int. Cl. H04W 24/02

(52) U.S. Cl. CPC H04W 24/02
USPC 370/254

(57) ABSTRACT

Disclosed are a duty cycle control method and apparatus to mitigate latency for duty cycle wireless low-power MAC. The duty cycle control method according to an embodiment of the present invention can control a duty cycle depending on traffic conditions in the asynchronous duty cycle-based low-power MAC to mitigate the packet transmission latency between nodes without significant damage of unique low power characteristics.

### CROSS-REFERENCE TO RELATED APPLICATION

This application claims priority from Korean Patent Application No. 10-2012-0115004, filed on Oct. 16, 2012, the entire disclosure of which is incorporated herein by reference for all purposes.

### BACKGROUND

1. Field

The present invention relates to a wireless sensor network technology, and more particularly, to a technology for mitigating latency between nodes by controlling a duty cycle in asynchronous low-power media access control (MAC) used in a wireless sensor network.

2. Description of the Related Art

In a wireless sensor network (WSN)-based on a link defined in IEEE 802.15.4, media access control (MAC) technology is classified into carrier sense multiple access/collision avoidance (CSMA/CA) type and time division multiplex access (TDMA) type. With TDMA technology, each node has a predetermined time for using a link and thus may use only its corresponding time slot and enter a sleep state (where a wireless communication chip is powered off), thereby being effective for low-power operation. However, TDMA technology has difficulties in terms of synchronization of time between nodes and maintenance of synchronized time. Thus, CSMA/CA technology has been widely used. CSMA/CA technology requires a senor node to be always in an active state and check wireless conditions in order for packet transmission and reception, thereby seriously wasting power. In particular, such waste of power may be directly related to the lifespan of a whole system when the sensor node uses a battery or energy harvesting device.

To solve the above power consumption problem, low-power MAC technologies have been proposed. The low-power MAC technologies usually use duty cycling in which each node is in a sleep state during most of time and periodically wakes up and then checks wireless conditions. The duty cycling may accomplish low power consumption by maximally reducing an idle listening operation in which most wireless communication chips continue to check wireless conditions normally in addition to during packet transmission and reception.

Duty cycling-based MAC technology is largely classified into a synchronous type and an asynchronous type. The synchronous type may include SMAC, T-MAC, etc. and synchronize all nodes of a network. Unlike TDMA, the synchronous type does not require a very precious time synchronization of a whole network, but has an overhead such as packet switching for maintaining time synchronization with low accuracy. The asynchronous duty cycling type does not have such synchronization and may include BMAC, X-MAC, etc.

In the asynchronous type, a transmitting node continuously transmits the same packet during one period until a receiving node receives the packet. In this case, the synchronization is not needed. A mechanism such as phase lock may be used to solve problems caused by continuous transmission of packets during one period. However, latency may occur because all nodes wake up at different times. In particular, a protocol used in request-response transmission, such as a constrained application protocol (CoAP) or hypertext transfer protocol (HTTP) may cause timeout and thus unnecessary packet retransmission.

Also, the asynchronous type can transmit up to one packet during one period. Accordingly, latency may significantly increase when one large packet such as 6LoWPAN needs to be broken into several fragments and then transmitted. Suppose that a node should continuously transmit two packets. If up to ten times transmission is possible during one period, the asynchronous duty cycle-based MAC sends two packets during two periods. That is, only two packets are transmitted during two periods when twenty times transmission is totally allowed, thereby deteriorating performances in terms of latency.

It is expected to widely use a web-based protocol, 6LoWPAN, etc. as well as an asynchronous duty cycle-based MAC protocol in a wireless sensor network field, in order to extend a battery life of a sensor node. Accordingly, it is needed to maintain a low-power property of the asynchronous duty cycle-based MAC protocol possibly and mitigate latency.

### SUMMARY

The asynchronous duty cycle-based low-power MAC is essential to extend a battery life of a sensor node. When the asynchronous duty cycle-based wireless MAC is applied to a request-response communication pattern such as web traffic or a wireless sensor network, such as 6LoWPAN, allowing continuous pack transmission, the entire performance may be degraded considerably due to latency.

In the asynchronous duty cycle-based low-power MAC, the duty cycle should be increased in order to reduce the latency. If to this end a wireless transceiver is allowed to be always powered on, the unique low-power characteristic is significantly damaged. Most traffic is transferred through multi-hops in view of characteristics of the wireless sensor networks. Thus, it is almost impossible to receive a response packet transmitted by a destination node spaced apart by several hops to tens of hops for a short time immediately after transmission. Accordingly, it is almost no use increasing an idle waiting time at a transmitting node, and thus most of the increased time is wasted.

According to an embodiment, a method and apparatus are proposed for controlling a duty cycle depending on traffic conditions in the asynchronous duty cycle-based low-power MAC to mitigate the packet transmission latency between nodes without significant damage of unique low power characteristics.

In one general aspect, a method of controlling a duty cycle for a transmitting node of a wireless sensor network to mitigate latency on the basis of an asynchronous media access control protocol includes increasing the duty cycle by increasing the number of wake-up times during one period for a predetermined time after the transmitting node transmits data, and transmitting and receiving the data with reduced latency due to increase of the duty cycle.

In the increasing of the duty cycle, the transmitting node may increase wake-up time and decrease sleep time in the duty cycle. Also, the transmitting node may increase the number of wake-up times during one period, for a predetermined time after packet transmission, and decrease the number of wake-up times to the original duty cycle if there is no packet transmission or reception for the predetermined time.

In the increasing of the duty cycle, the transmitting node may determine duration and degree of the increased duty cycle according to a duty cycle in an idle state and characteristics of an application. The transmitting node may predict a packet response time from a receiving node on the basis of an average of packet round trip time from the transmitting node to the receiving node and then determine the duration and degree of the increased duty cycle on the basis of the predicted time.

In another general aspect, a method of controlling a duty cycle for a receiving node of a wireless sensor network to mitigate latency on the basis of an asynchronous media access control protocol includes increasing the duty cycle by increasing the number of wake-up times during one period for a predetermined time after the receiving node receives data, and transmitting and receiving the data with reduced latency due to increase of the duty cycle.

In the increasing of the duty cycle, the receiving node may increase wake-up time and decrease sleep time in the duty cycle. Also, the receiving node may increase the number of wake-up times during one period, for a predetermined time after packet reception, and decrease the number of wake-up times to the original duty cycle if there is no packet transmission or reception for the predetermined time.

In the increasing of the duty cycle, the receiving node may determine duration and degree of the increased duty cycle according to a duty cycle in an idle state and characteristics of an application.

In the transmitting and receiving of data, the receiving node may generate a response packet in response to the request packet received from the transmitting node, and transmit the response packet to the transmitting node. Alternatively, the receiving node may continuously receive packets from the transmitting node.

Other features and aspects will be apparent from the following detailed description, the drawings, and the claims.

### BRIEF DESCRIPTION OF THE DRAWINGS

FIG. 1 is a block diagram showing a sensor node according to an embodiment of the present invention.

FIG. 2 is a reference view showing a typical packet communication flow between nodes in low-power MAC.

FIG. 3 is a reference view showing a packet communication flow between nodes in low-power MAC according to an embodiment of the present invention.

FIG. 4 is a reference view showing a request-response-based traffic pattern, in which latency decreases as a duty cycle increases, according to an embodiment of the present invention.

FIGS. 5a and 5b are reference views showing a continuous transmission traffic pattern, in which latency decreases as a duty cycle increases, according to an embodiment of the present invention.

FIG. 6 is a flowchart illustrating a method of controlling a duty cycle to mitigate latency between nodes according to an embodiment of the present invention.

FIG. 7 is a flowchart illustrating a method of controlling a duty cycle to mitigate latency between nodes according to another embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, embodiments of the present invention will be described in detail with reference to the accompanying drawings. In the following description, when the detailed description of the relevant known function or configuration is determined to unnecessarily obscure the important point of the present invention, the detailed description will be omitted. Also, the terms described below are defined with consideration of the functions in the present invention, and thus may vary depending on intention of a user or an operator, or a conventional practice. Accordingly, the definition would be made on the basis of the whole specification.

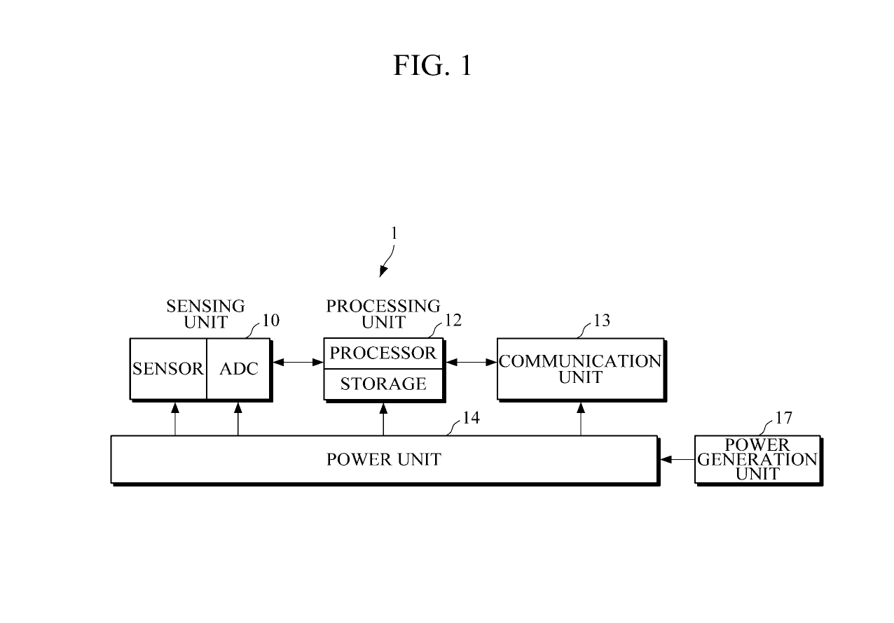

FIG. 1 is a block diagram showing a sensor node 1 according to an embodiment of the present invention.

Referring to FIG. 1, a sensor node 1 of a wireless sensor network (WSN) includes a sensing unit 10 including a sensor and an analog-to-digital converter (ADC), a processing unit including a processor and a storage, a communication unit 13 configured to transmit and receive data, and a power unit 14 configured to supply power. Also, the sensor node 1 may further include a power generation unit 17 depending to the use of the sensor.

The sensor node 1 uses a limited energy source such as a battery but should guarantee its operation for several months to years. Accordingly, it is important to efficiently manage energy. Thus, much research has been conducted on low-power design, one of which is to use a duty cycle of alternating between a wake-up state and sleep state in a media access control (MAC) protocol field.

The MAC protocol may be classified into a synchronous MAC protocol with synchronization between sensor nodes and an asynchronous MAC protocol without synchronization between sensor nodes. Representative asynchronous MAC protocols include B-MAC, Wise-MAC, X-MAC, etc. However, in the asynchronous MAC protocol, a wake-up state of a receiving node is not known, and thus data to be transmitted may be delayed by a maximum duty cycle period per link. This may be a limitation for a web protocol using CoAP or HTTP or 6LoWPAN causing continuous packet transmission, in a sensor network application service requiring real-time operations such as detection or monitoring of invasion. Accordingly, the present invention proposes an algorithm for reducing transmission latency that is the greatest limitation of the asynchronous MAC protocol.

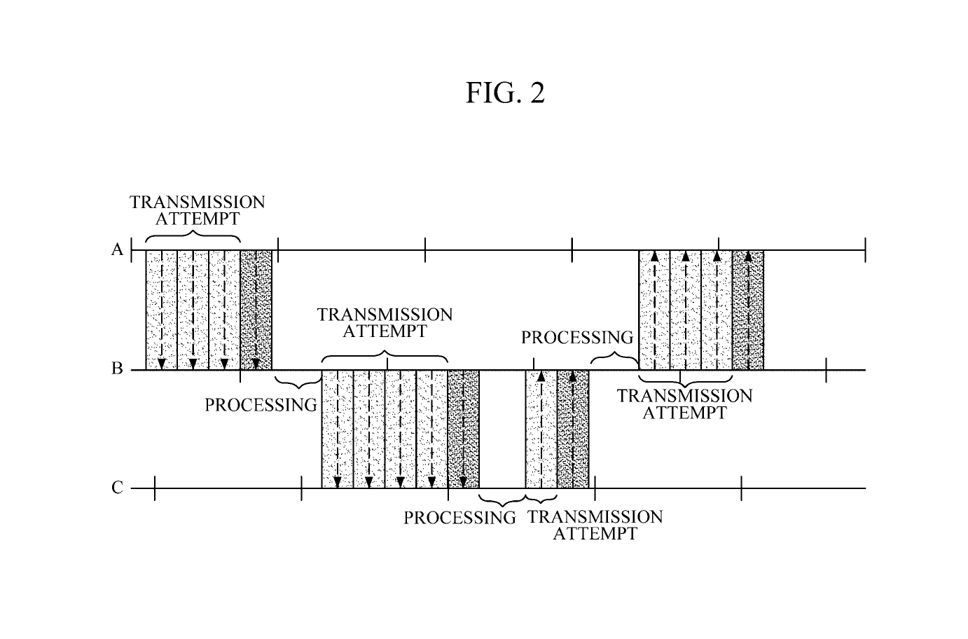

FIG. 2 is a reference view showing a typical packet communication flow between nodes in low-power MAC.

In FIG. 2, “A” transmits a request packet to “C” through “B” and then receives a response packet from “C” through “B”. “A,” “B,” and “C” represent nodes, respectively, a horizontal axis represents time, and a scale of the horizontal axis represents a time point when a node wakes up.

To provide a description of a typical packet communication process between nodes with reference to FIG. 2, “A” attempts to transmit a packet to “B” four times in total. In first, second, and third attempts, “B” is in a sleep state and thus the packet is lost. In fourth attempt, “B” wakes up to receive the packet from “A”. “B” also attempts to transmit the packet to “C” five times in total. In first, second, third, and fourth attempts, “C” is in a sleep state and thus the packet is lost. In fifth attempt, “C” wakes up to receive the packet. In FIG. 2, the processing represents a process of processing a packet. For example, the processing in “B” represents a process of transmitting (routing) a packet to “C”, and the processing in “C” represents a process of generating a response packet. The response packet generated by “C” is transmitted through “B” to “A” that has first requested the response packet, via six times of attempts. Accordingly, a case in which a sensor is continuously in a wake-up state may seem to be more efficient. However, in general, a wireless communication chip in a wake-up state significantly consumes power. Thus, a core concept of the duty cycle in MAC is that the sensor is in a sleep state during most of time when a packet is not transmitted or received.

Referring to FIG. 2, when a transmitting node transmits a packet, the packet transmission is completed only after a receiving node wakes up. That is, each node has a wake-up time different from each other, thus causing unnecessary latency. The latency is negligible in a short distance such as one or two hops, but increases as the number of hops increases. The latency in a link layer may affect upper layers. In particular, when there is no response packet at an end even after a certain time, a protocol for performing retransmission, such as Transmission Control Protocol (TCP) or Constrained Application Protocol (CoAP), may recognize the excessive latency as packet loss to retransmit the packet.

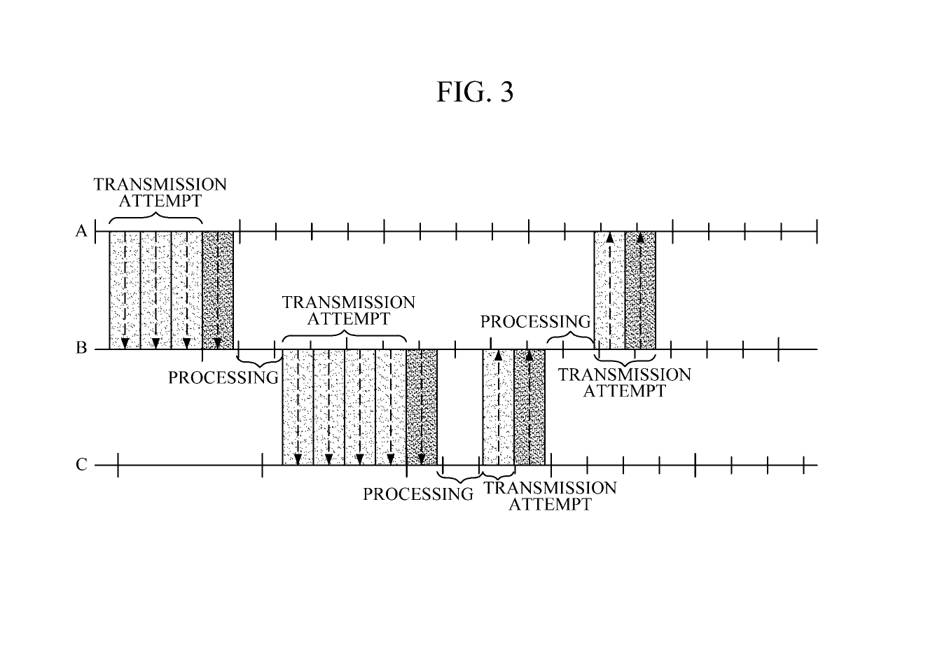

To solve the above latency problem, a method of controlling a wake-up timing between nodes to synchronize the nodes is proposed. The method is one of methods used in the synchronous low-power MAC, which may cause a problem of an overhead due to synchronization. As another solution, a method of temporarily increasing the wake-up time is proposed. In this case, when there is no communication activity during the increased wake-up time, the low-power efficiency is reduced. The present invention intends to solve the above problems using a method of temporarily increasing the number of wake-up times during one period. This will be described with reference to FIG. 3.

FIG. 3 is a reference view showing a packet communication flow between nodes in low-power MAC according to an embodiment of the present invention.

Referring to FIG. 3, the operation of first transmitting a request packet (A->B->C) is the same as the typical process in MAC, as illustrated in FIG. 2. However, according to the present invention, the operation of transmitting a response packet (C->B->A) may be performed at a much higher rate than in the conventional method by increasing the duty cycle after “A” transmits a packet to reduce latency for packet transmission and reception.

The difference in packet transmission and reception processes shown in FIGS. 2 and 3 is to increase the number of scale times, that is, the number of wake-up times to increase the duty cycle in FIG. 3. The duty cycle is the percent of time when power is on during one period. Thus, in the present invention, increasing the duty cycle indicates waking up more frequently to increase the percent of time when power is on. With the increase of the duty cycle, the response latency from “C” to “A” may be reduced. Thus, “A” may receive a packet from “C” at a high rate.

Both the transmitting node and the receiving node may increase their duty cycles. That is, the transmitting node increases its duty cycle because the transmitting node may have a response packet to receive, and the receiving node increases its duty cycle because the receiving node may have a request packet to be continuously transmitted from the transmitting node.

According to an embodiment of the present invention, each node transiently increases the number of wake-up times during one period of packet transmission or reception. And then, the node decreases the number of wake-up times to the original duty cycle when there is no packet transmission or reception for a certain time.

The method of increasing a duty cycle according to the present invention increases the number of wake-up times instead of increasing an idle waiting time, thereby disallowing great energy waste even when there is no communication activity during the time when the duty cycle is transiently increased.

According to an embodiment, each node determines duration and degree of the increased duty cycle according to a duty cycle in an idle state and characteristics of an application. For example, each node may measure and store an average round trip time for each final destination, and then predict the duration and increase degree using the average round trip time. If “A” statistically knows that it almost takes “x” seconds on average to receive a response packet after transmitting a packet to “C”, “A” may roughly predict when the response packet will be received from “C”. Accordingly, “A” may determine the duration and degree of the increased duty cycle on the basis of the predicted time. However, the above embodiment of the present invention is illustrative, and the duration and degree of the increased duty cycle may be changed variously.

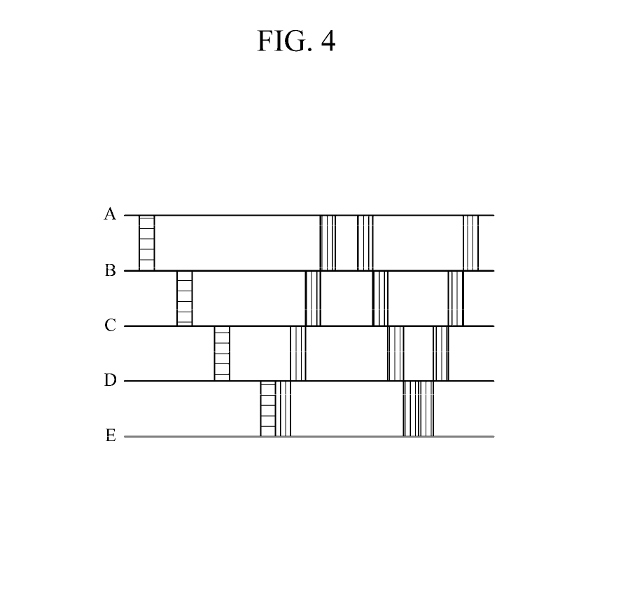

FIG. 4 is a reference view showing a request-response-based traffic pattern, in which latency decreases as a duty cycle increases, according to an embodiment of the present invention.

The present invention is more effective to a traffic pattern where the same route is used several times than one-time and one-way traffic. The traffic pattern may include a web protocol such as HTTP, CoAP, etc. based on a request-response process. According to the traffic pattern, a packet is transmitted between nodes as shown in FIG. 4. Referring to FIG. 4, it can be seen that latency is too high due to a low duty cycle when a packet is first transmitted from “A” to “E,” but latencies are reduced when a response packet in response to the request packet and following packets are transmitted.

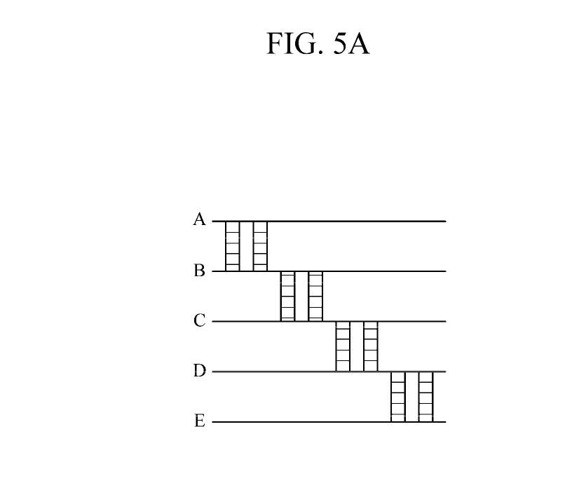

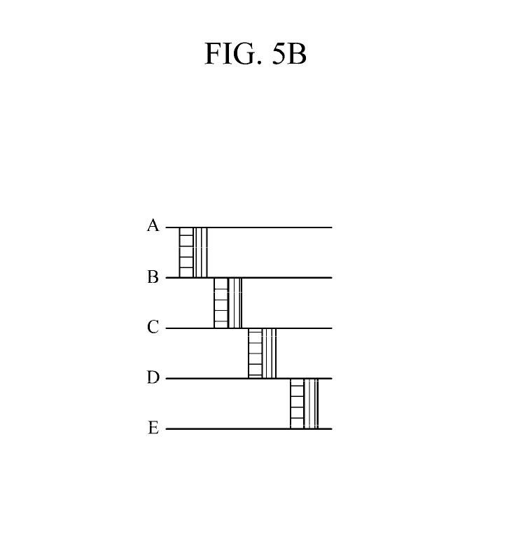

FIGS. 5a and 5b are reference views showing a continuous transmission traffic pattern, in which latency decreases as a duty cycle increases, according to an embodiment of the present invention.

A duty cycle control technology of the present invention may be effective even when several packets are transmitted at one time. The traffic packet may include a 6LoWPAN fragmentation packet. In 6LoWPAN, in order to transmit an IPv6 packet over an IEEE 802.15.4 network, a long packet needs to be broken into several fragments and then transmitted. As shown in FIG. 5b, the present invention enables the latency of continuous transmission traffic to be reduced. FIG. 5a shows a process of transmitting continuous packets in a typical low-power MAC. FIG. 5b shows a packet having an effect of latency mitigation according to the present invention. Referring to FIG. 5b, it can be seen that the latency for packet transmission is reduced, compared with FIG. 5a.

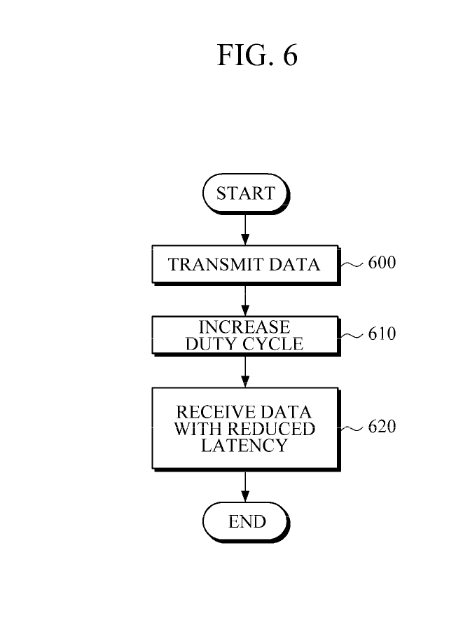

FIG. 6 is a flowchart illustrating a method of controlling a duty cycle to mitigate latency between nodes according to an embodiment of the present invention.

Referring to FIG. 6, a transmitting node of a wireless sensor network transmits data on the basis of the asynchronous MAC (600) and then increases the number of wake-up times during one period to increase the duty cycle (610). The transmitting node in increasing the duty cycle (610) may increase wake-up time and decrease sleep time in the duty cycle.

According to an embodiment, the transmitting node in increasing the duty cycle (610) may increase the number of wake-up times during one period, for a predetermined time after packet transmission, and decrease the number of wake-up times to the original duty cycle if there is no packet transmission or reception for the predetermined time.

According to an embodiment, the transmitting node in increasing the duty cycle (610) may determine duration and degree of the increased duty cycle according to a duty cycle in an idle state and characteristics of an application. For example, the transmitting node may predict a packet response time from the receiving node on the basis of the packet round trip time from the transmitting node to the receiving node and then determine duration and degree of the increased duty cycle on the basis of the predicted time.

Next, the transmitting node transmits or receives data with reduced latency due to increase of the duty cycle (620). According to an embodiment, the transmitting node may receive, from the receiving node, a response packet in response to the request packet that has been transmitted by the transmitting node through a request-response packet transmission protocol. Alternatively, the transmitting node may continuously transmit a 6LoWPAN fragmentation packet.

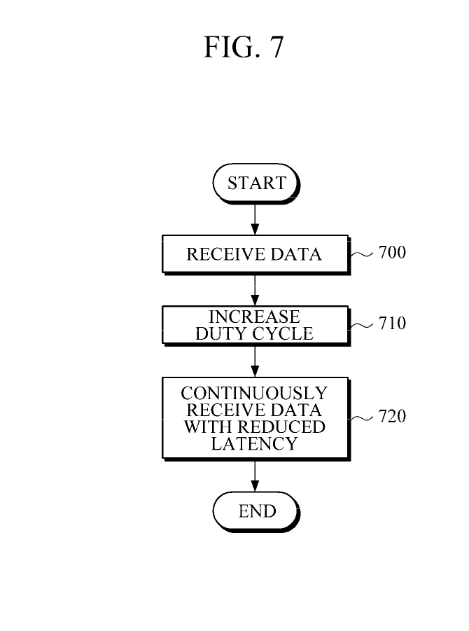

FIG. 7 is a flowchart illustrating a method of controlling a duty cycle to mitigate latency between nodes according to another embodiment of the present invention.

Referring to FIG. 7, a receiving node of a wireless sensor network receives data on the basis of the asynchronous MAC (700) and then increase the number of wake-up times during one period to increase the duty cycle (710). The receiving node in increasing the duty cycle (710) may increase wake-up time and decrease sleep time in the duty cycle.

According to an embodiment, the receiving node in increasing the duty cycle (710) may increase the number of wake-up times during one period, for a predetermined time after packet reception, and decrease the number of wake-up times to the original duty cycle if there is no packet transmission or reception for the predetermined time.

The receiving node in increasing the duty cycle (710) may determine duration and degree of the increased duty cycle according to a duty cycle in an idle state and characteristics of an application.

Next, the receiving node transmits or receives data with reduced latency due to increase of the duty cycle (720). According to an embodiment, the receiving node may generate a response packet in response to the request packet received from the transmitting node, and transmit the response packet to the transmitting node. According to another embodiment, the receiving node may continuously receive packets from the transmitting node.

According to an embodiment, it is possible to control the duty cycle depending on traffic conditions in the asynchronous duty cycle-based low-power MAC to mitigate the packet transmission latency between nodes without significant damage of unique low power characteristics.

This invention has been particularly shown and described with reference to preferred embodiments thereof. It will be understood by those skilled in the art that various changes in form and details may be made therein without departing from the spirit and scope of the invention as defined by the appended claims. Accordingly, the referred embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of controlling a duty cycle for a transmitting node of a wireless sensor network to mitigate latency on the basis of an asynchronous media access control protocol, the method comprising:
increasing the duty cycle by increasing the number of wake-up times during one period after the transmitting node transmits data; and
transmitting and receiving the data with reduced latency due to increase of the duty cycle.

2. The method of claim 1, wherein the increasing of the duty circle comprises increasing wake-up time and decreasing sleep time in the duty cycle.

3. The method of claim 1, wherein the increasing of the duty cycle comprises increasing the number of wake-up times during one period, for a predetermined time after packet transmission, and decreasing the number of wake-up times to the original duty cycle if there is no packet transmission or reception for the predetermined time.

4. The method of claim 1, wherein the increasing of the duty circle comprises determining duration and degree of the increased duty cycle according to a duty cycle in an idle state and characteristics of an application.

5. The method of claim 4, wherein the increasing of the duty cycle comprises predicting a packet response time from a receiving node on the basis of an average of packet round trip time from the transmitting node to the receiving node and then determining the duration and degree of the increased duty cycle on the basis of the predicted time.

6. The method of claim 1, wherein the transmitting and receiving of data comprises receiving a response packet from the receiving node in response to a request packet transmitted by the transmitting node.

7. The method of claim 1, wherein the transmitting and receiving of data comprises continuously transmitting packets at the transmitting node.

8. A method of controlling a duty cycle for a receiving node of a wireless sensor network to mitigate latency on the basis of an asynchronous media access control protocol, the method comprising:
increasing the duty cycle by increasing the number of wake-up times during one period after the receiving node receives data; and
transmitting and receiving the data with reduced latency due to increase of the duty cycle.

9. The method of claim 8, wherein the increasing of the duty circle comprises increasing wake-up time and decreasing sleep time in the duty cycle.

10. The method of claim 8, wherein the increasing of the duty cycle comprises increasing the number of wake-up times during one period, for a predetermined time after packet reception, and decreasing the number of wake-up times to the original duty cycle if there is no packet transmission or reception for the predetermined time.

11. The method of claim 8, wherein the increasing of the duty circle comprises determining duration and degree of the increased duty cycle according to a duty cycle in an idle state and characteristics of an application.

12. The method of claim 8, wherein the transmitting and receiving of data comprises generating a response packet in response to the request packet received from the transmitting node to transmit the response packet to the transmitting node.

13. The method of claim 8, wherein the transmitting and receiving of data comprises continuously receiving packets from the transmitting node.
